(19) United States
(12) Patent Application Publication
(10) Pub. No.: US 2025/0163626 A1
(43) Pub. Date: May 22, 2025

(54) WASHING MACHINE HAVING OPERATING PANEL ASSEMBLY

(71) Applicant: SAMSUNG ELECTRONICS CO., LTD., Suwon-si (KR)

(72) Inventors: Junga PARK, Suwon-si (KR); Jungyoon KIM, Suwon-si (KR); Hyunseop PARK, Suwon-si (KR); Wungchul CHOI, Suwon-si (KR)

(73) Assignee: SAMSUNG ELECTRONICS CO., LTD., Suwon-si (KR)

(21) Appl. No.: 19/028,929

(22) Filed: Jan. 17, 2025

Related U.S. Application Data
(63) Continuation of application No. PCT/KR2023/010867, filed on Jul. 26, 2023.

(30) Foreign Application Priority Data
Oct. 28, 2022 (KR) 10-2022-0141615
Feb. 23, 2023 (KR) 10-2023-0024586

(51) Int. Cl. D06F 34/30; D06F 23/02; D06F 23/04; D06F 34/32; D06F 105/58; F16B 5/02

(52) U.S. Cl. CPC D06F 34/30; D06F 23/02; D06F 23/04; D06F 34/32; F16B 5/02; D06F 2105/58

(57) ABSTRACT

A washing machine includes: a main body including: a first tub; a washing tub rotatable inside the first tub; a laundry inlet through which laundry is loaded into the washing tub; and a door configured to open and close the laundry inlet; and a manipulation panel assembly configured to: receive a manipulation input for wash settings or spin-drying settings; and display an operation state of the washing machine. The manipulation panel assembly includes: a display board; a jog board on which a jog switch is mounted; a first connector on any one of the display board and the jog board, and coupled to the other one of the display board and the jog board; and a manipulation panel accommodating the display board and the jog board.

### CROSS-REFERENCE TO RELATED APPLICATIONS

This application is a continuation of International Application No. PCT/KR2023/010867, filed on Jul. 26, 2023, which is based on and claims priority to Korean Patent Application No. 10-2022-0141615, filed on Oct. 28, 2022, in the Korean Intellectual Property Office, and Korean Patent Application No. 10-2022-0024586, filed on Feb. 23, 2023, in the Korean Intellectual Property Office, the disclosures of which are incorporated by reference herein in their entireties.

### BACKGROUND

### 1. Field

The present disclosure relates to a washing machine having a manipulation panel assembly, and an electronic device.

### 2. Description of Related Art

An electrical appliance, such as a washing machine or a dryer, includes a manipulation panel assembly configured to receive a user input for an operation of the electrical appliance and indicate the operation of the electrical appliance. The manipulation panel assembly may include a jog board having a jog switch, and a display board having a manipulation unit and an indication unit. The jog board and the display board are coupled to a manipulation panel. An operating shaft of the jog switch protrudes from a surface of the manipulation panel, and a jog dial is coupled to the operating shaft. The jog board and the display board are electrically connected to each other by a wire harness.

### SUMMARY

According to an aspect of the present disclosure, a washing machine includes: a main body including: a first tub; a washing tub rotatable inside the first tub; a laundry inlet through which laundry is loaded into the washing tub; and a door configured to open and close the laundry inlet; and a manipulation panel assembly configured to: receive a manipulation input for wash settings or spin-drying settings; and display an operation state of the washing machine. The manipulation panel assembly includes: a display board; a jog board on which a jog switch is mounted; a first connector on any one of the display board and the jog board, and coupled to the other one of the display board and the jog board; and a manipulation panel accommodating the display board and the jog board.

The display board and the jog board may be coupled to each other by the first connector, and form a board module.

The jog board may be spaced apart from the display board rearward in a thickness direction of the display board.

The jog board may be parallel to the display board.

The first connector may be soldered to the other one of the display board and the jog board.

The washing machine may further include a second connector on the display board in a state in which the first connector is on the jog board, or on the jog board in a state in which the first connector is on the display board, and electrically and mechanically coupled to the first connector.

The first connector and the second connector may be coupled to each other in a thickness direction of the display board.

The first connector and the second connector may be coupled to each other in a lateral direction that is orthogonal to a thickness direction of the display board.

The washer machine may further include a jog through hole in the display board. The jog board may face the manipulation panel through the jog through hole.

The jog board may be in one side portion of the display board in a lateral direction that is orthogonal to a thickness direction of the display board.

The manipulation panel may include: one or more support ribs configured to support the jog board; and one or more fastening bosses to which the jog board is fastened.

The manipulation panel may include a reflector panel and an exterior panel in front of the reflector panel. The jog board and the display board may be coupled to the reflector panel.

The one or more support ribs may be configured to support the jog board, and the one or more fastening bosses may be in the reflector panel.

The washing machine may further include jog indication elements configured to emit light based on a manipulation of the jog switch. The jog indication elements may be in the display board.

The washing machine may further include jog indication elements configured to emit light based on a manipulation of the jog switch. The jog indication elements may be in the jog board.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic exploded perspective view of a manipulation panel assembly for an electrical appliance, according to various embodiments of the present disclosure;

FIG. 2 is a schematic exploded perspective view of a reflector panel and a board module in the manipulation panel assembly for an electrical appliance illustrated in FIG. 1, according to various embodiments of the present disclosure;

FIG. 3 is a partial perspective view of a coupling structure between a display board and a jog board using a first connector in the manipulation panel assembly for an electrical appliance illustrated in FIG. 1, according to various embodiments of the present disclosure;

FIG. 4 is a cross-sectional view taken along line X1-X1′ of FIG. 3;

FIG. 5 is a partially exploded perspective view schematically illustrating a structure in which a board module is coupled to a reflector panel;

FIG. 6 illustrates a structure in which a display module and a jog module are manufactured in an integrated manner;

FIG. 7 illustrates a structure in which a display module and a jog module are manufactured in an integrated manner;

FIG. 8 is a cross-sectional view illustrating a coupling structure between a first connector and a second connector, and corresponding to FIG. 4;

FIG. 9 is a cross-sectional view illustrating a coupling structure between a first connector and a second connector, and corresponding to FIG. 4;

FIG. 10 is a cross-sectional view illustrating a coupling structure between a first connector and a second connector, and corresponding to FIG. 4;

FIG. 11 is a schematic plan view of a manipulation panel assembly according to various embodiments of the present disclosure;

FIG. 12 is a schematic plan view of a manipulation panel assembly according to various embodiments of the present disclosure;

FIG. 13 is a schematic cross-sectional view of a manipulation panel assembly according to various embodiments of the present disclosure, and corresponding to FIG. 4; and

FIGS. 14 and 15 are schematic perspective views of an electrical appliance according to various embodiments of the present disclosure, wherein FIG. 14 illustrates a top-loading washing machine and FIG. 15 illustrates a front-loading washing machine.

### DETAILED DESCRIPTION

It should be appreciated that various embodiments of the present disclosure and the terms used therein are not intended to limit the technological features set forth herein to particular embodiments, and include various changes, equivalents, or alternatives for a corresponding embodiment.

With regard to the description of the drawings, similar reference numerals may be used to refer to similar or related elements.

A singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, the term “and/or” includes any one or a combination of a plurality of related recited elements.

As used herein, such terms as “1st” and “2nd,” or “first” and “second” may be used to simply distinguish a corresponding component from another, and does not limit the components in any other respect (e.g., importance or order).

When an element (e.g., a first element) is referred to, with or without the term “operatively” or “communicatively”, as being “coupled with,” “coupled to,” “connected with,” or “connected to” another element (e.g., a second element), it means that the element may be connected to the other element directly (e.g., in a wired manner), wirelessly, or via a third element.

As used herein, such terms as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

When an element is referred to as being “connected to,” “coupled to,” “supported by,” or “in contact with” another element, it means that the element is directly connected to, coupled to, supported by, or in contact with the other element, or that the element is indirectly connected to, coupled to, supported by, or in contact with the other element via a third element.

When an element is referred to as being “on” another element, it means that the element is in contact with the other element, or that still another element is present between the element and the other element.

A washing machine according to various embodiments may perform washing, rinse, spin-drying, and drying cycles. The washing machine is an example of a garment treatment device, and the garment treatment device is a concept that encompasses devices for washing a garment (i.e., an article to be washed or an article to be dried), devices for drying a garment, and devices capable of washing and drying a garment.

A washing machine according to various embodiments may include a top-loading washing machine in which an inlet for loading or unloading laundry is provided to face upward, or a front-loading washing machine in which an inlet for loading or unloading laundry is provided to face the front. A washing machine according to various embodiments may include a washing machine of a loading type other than top-loading washing machines and front loading washing machines.

A top-loading washing machine may wash laundry by using a water current generated by a rotating body such as a pulsator. A front-loading washing machine may wash laundry by rotating a drum to repeatedly raise and fall the laundry. A front-loading washing machine may include a drying-and-washing machine capable of drying laundry accommodated in a drum. The drying-and-washing machine may include a hot-air supply device for supplying high-temperature air into the drum and a condensation device for removing moisture from air discharged from the drum. For example, the drying-and-washing machine may include a heat pump device. A washing machine according to various embodiments may include a washing machine with a washing method other than the washing methods described above.

A washing machine according to various embodiments may include a housing for accommodating various components therein. The housing may be provided in the form of a box with a laundry inlet formed on one side.

The washing machine may include a door for opening and closing the laundry inlet. The door may be mounted on the housing to be rotatable by a hinge. At least a portion of the door may be transparent or translucent such that the interior of the housing is visible.

The washing machine may include a tub provided inside the housing to store water. The tub may be provided in a substantially cylindrical shape with a tub opening formed on one side, and may be arranged inside the housing such that the tub opening is arranged to correspond to the laundry inlet.

The tub may be connected to the housing by a damper. The damper may absorb vibration that occurs when the drum rotates, to attenuate the vibration transmitted to the housing.

The washing machine may include a drum provided to accommodate laundry.

The drum may be arranged inside the tub such that a drum opening provided on one side corresponds to the laundry inlet and the tub opening. Laundry may sequentially pass through the laundry inlet, the tub opening, and the drum opening to be accommodated in the drum, or may be unloaded from the drum.

The drum may rotate inside the tub to perform each operation according to washing, rinse, and/or spin-drying cycles. A plurality of holes may be formed on a cylindrical wall of the drum such that water stored in the tub may flow into or out of the drum.

The washing machine may include a driving device configured to rotate the drum. The driving device may include a driving motor and a rotating shaft for transmitting a driving force generated by the driving motor to the drum. The rotating shaft may penetrate the tub to be connected to the drum.

The driving device may rotate the drum forward or backward to perform each operation according to washing, rinse, and/or spin-drying cycles, or a drying cycle.

The washing machine may include a water supply device configured to supply water to the tub. The water supply device may include a water supply pipe and a water supply valve provided in the water supply pipe. The water supply pipe may be connected to an external water supply source. The water supply pipe may extend from the external water supply source to a detergent supply device and/or the tub. Water may be supplied to the tub through the detergent supply device. Water may be supplied to the tub without passing through the detergent supply device.

The water supply valve may open or close the water supply pipe in response to an electrical signal from a control unit. The water supply valve may allow or block supply of water to the tub from the external water supply source. The water supply valve may include, for example, a solenoid valve that is opened and closed in response to an electrical signal.

The washing machine may include a detergent supply device configured to supply a detergent to the tub. The detergent supply device may include a manual detergent supply device that requires a user to input a detergent to be used in each washing process, and an automatic detergent supply device that stores a large amount of detergent and automatically inputs a predetermined amount of detergent in a washing process. The detergent supply device may include a detergent compartment for storing a detergent. The detergent supply device may be configured to supply a detergent into the tub in a water supply process. Water supplied through the water supply pipe may pass through the detergent supply device to be mixed with a detergent. The water mixed with the detergent may be supplied into the tub. The term ‘detergent’ encompasses pre-wash detergents, main wash detergents, fabric softeners, bleaching agents, and the like, and the detergent compartment may be partitioned into a pre-wash detergent storage area, a main wash detergent storage area, a fabric softener storage area, and a bleaching agent storage area.

The washing machine may include a drainage device configured to discharge water accommodated in the tub to the outside. The drainage device may include a drain pipe extending from a lower portion of the tub to the outside of the housing, a drain valve provided in the drain pipe to open and close the drain pipe, and a pump provided on the drain pipe. The pump may pump water from the drain pipe to the outside of the housing.

The washing machine may include a control panel arranged on one side surface of the housing. The control panel may provide a user interface for the user to interact with the washing machine. The user interface may include at least one input interface and at least one output interface.

The at least one input interface may convert sensory information received from the user into an electrical signal.

The at least one input interface may include a power button, an operation button, a course selection dial (or a course selection button), and washing/rinse/spin-drying setting buttons. The at least one input interface may include, for example, a tact switch, a push switch, a slide switch, a toggle switch, a microswitch, a touch switch, a touch pad, a touch screen, a jog dial, and/or a microphone.

The at least one output interface may visually or audibly provide information related to an operation of the washing machine to the user.

For example, the at least one output interface may provide the user with information related to a wash cycle, an operating time of the washing machine, and wash settings/rinse settings/spin-drying settings. Information about an operation of the washing machine may be output through a screen, an indicator, a voice, or the like. The at least one output interface may include, for example, a liquid-crystal display (LCD) panel, a light-emitting diode (LED) panel, a speaker, and the like.

The washing machine may include a communication module for communicating with an external device in a wired and/or wireless manner.

The communication module may include at least one of a short-range wireless module or a long-range communication module.

The communication module may transmit or receive data to or from an external device (e.g., a server, a user device, and/or a home appliance). For example, the communication module may establish a communication with a server, a user device, and/or a home appliance, and transmit and receive various types of data.

To this end, the communication module may support establishment of a direct (e.g., wired) communication channel or a wireless communication channel between external devices, and communication through the established communication channel. According to various embodiments, the communication module may include a wireless communication module (e.g., a cellular communication module, a short-range wireless communication module, or a global navigation satellite system (GNSS) communication module) or a wired communication module (e.g., a local area network (LAN) communication module or a power line communication module). The corresponding communication module may communicate with an external device through a first network (e.g., a short-range communication network such as Bluetooth, Wi-Fi Direct, or Infrared Data Association (IrDA)) or a second network (e.g., a long-range communication network such as a legacy cellular network, a 5G network, a next-generation communication network, the Internet, or a computer network (e.g., a LAN or a wide area network (WAN)). These types of communication modules may be integrated into one component (e.g., a single chip) or implemented by a plurality of separate components (e.g., a plurality of chips).

The short-range wireless communication module may include, but is not limited to, a Bluetooth communication module, a Bluetooth Low Energy (BLE) communication module, a Near Field Communication (NFC) module, a wireless local area network (WLAN) (Wi-Fi) communication module, a Zigbee communication module, an IrDA communication module, a Wi-Fi Direct (WFD) communication module, an ultra-wideband (UWB) communication module, an Ant+ communication module, a microwave (uWave) communication module, and the like.

The long-range communication module may include a communication module for performing various types of long-range communication, and may include a mobile communication unit. The mobile communication unit transmits and receives radio signals to and from at least one of a base station, an external terminal, or a server, on a mobile communication network.

In various embodiments, the communication module may communicate with an external device such as a server, a user device, and other home appliances, through a nearby access point (AP). The AP may connect a LAN to which the washing machine or a user device is connected, to a wide area network (WAN) to which a server is connected. The washing machine or user device may be connected to the server via the WAN. The control unit may control various components of the washing machine (e.g., the driving motor, the water supply valve). The control unit may control various components of the washing machine to perform at least one of a water supply cycle, a washing cycle, a rinse cycle, and/or a spin-drying cycle, according to a user input. For example, the control unit may control the driving motor to adjust the rotational speed of the drum, or control the water supply valve of the water supply device to supply water to the tub.

The control unit may include hardware such as a central processing unit (CPU) or a memory, and software such as a control program. For example, the control unit may include at least one memory storing an algorithm for controlling operations of components in the washing machine, and data in the form of a program, and at least one processor configured to perform the above-described operations by using the data stored in the at least one memory. Each of the memory and the processor may be implemented as a separate chip. The processor may include one or more processor chips, or may include one or more processing cores. The memory may include one or more memory chips, or may include one or more memory blocks. In addition, the memory and the processor may be implemented as a single chip.

Although the terms used herein are selected from among common terms that are currently widely used in consideration of their functions in the present disclosure, the terms may be different according to an intention of one of ordinary skill in the art, a precedent, or the advent of new technology. Also, in particular cases, the terms are discretionally selected by the applicant of the present disclosure, in which case, the meaning of those terms will be described in detail in the corresponding part of the detailed description. Therefore, the terms used herein are not merely designations of the terms, but the terms are defined based on the meaning of the terms and content throughout the present disclosure. Throughout the present specification, when a part “includes” a component, it means that the part may additionally include other components rather than excluding other components as long as there is no particular opposing recitation.

According to an aspect of the present disclosure, an objective is to simplify a process of manufacturing a manipulation panel assembly (or a control panel) of an electrical appliance, for example, a washing machine or a dryer. According to an aspect of the present disclosure, an objective is to reduce the manufacturing cost of a manipulation panel assembly. According to an aspect of the present disclosure, an objective is to simplify a connection structure between a display board and a jog board. According to an aspect of the present disclosure, an objective is to reduce a decrease in the brightness of an indication unit. The technical objectives of the present disclosure are not limited to those mentioned above, and other technical objectives not mentioned herein may be clearly understood by those of skill in the art from descriptions below.

Hereinafter, embodiments will be described with reference to the accompanying drawings in such a manner that the embodiments may be easily carried out by those of skill in the art. The present disclosure may, however, be embodied in many different forms and should not be construed as being limited to various embodiments set forth herein. In order to clearly describe the present disclosure, portions that are not relevant to the description of the present disclosure are omitted in the drawings, and similar reference numerals are assigned to similar elements throughout the present specification. Hereinafter, embodiments of the present disclosure will be described with reference to the accompanying drawings.

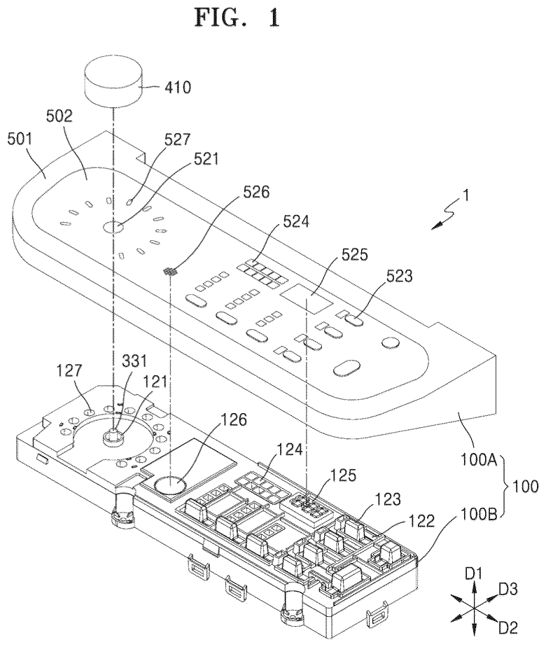

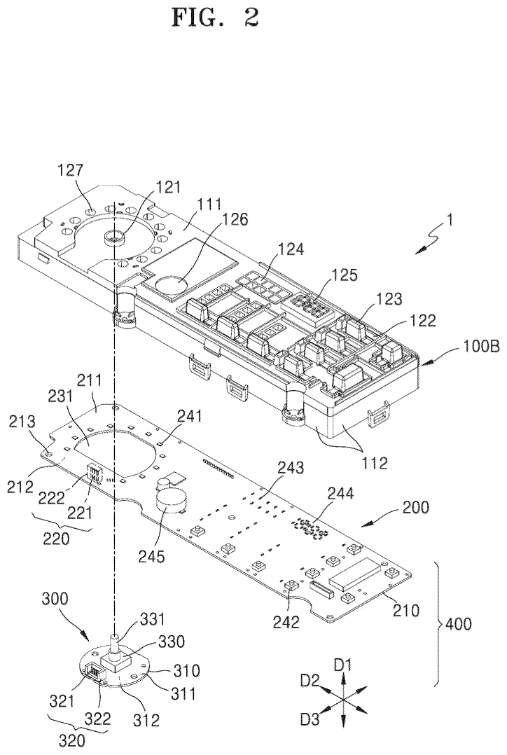

FIG. 1 is a schematic exploded perspective view of a manipulation panel assembly 1 for an electrical appliance, according to various embodiments of the present disclosure. FIG. 2 is a schematic exploded perspective view of a reflector panel 100B and a board module 400 in the manipulation panel assembly 1 for an electrical appliance illustrated in FIG. 1, according to various embodiments of the present disclosure. Referring to FIGS. 1 and 2, the manipulation panel assembly 1 for an electrical appliance according to various embodiments of the present disclosure may include a manipulation panel 100, a display board 210, a jog board 310, and a first connector 220. The manipulation panel assembly 1 may be referred to as an “indication manipulation unit” or a “control panel”. A jog switch 330 is mounted on the jog board 310. The first connector 220 is provided in any one of the display board 210 and the jog board 310. The first connector 220 is connected to the other one of the display board 210 and the jog board 310. For example, when the first connector 220 is provided in the display board 210, then it is connected to the jog board 310. Additionally, when the first connector 220 is provided in the jog board 310, then it is connected to the display board 210. The display board 210 and the jog board 310 are mechanically coupled and electrically connected to each other by the first connector 220. The board module 400 may be formed, in which the display board 210 and the jog board 310 are coupled to each other by the first connector 220. The manipulation panel 100 accommodates the display board 210 and the jog board 310.

The other one of the display board 210 and the jog board 310 may be coupled to the first connector 220 by various coupling structures that may mechanically couple and electrically connect the display board 210 to the jog board 310. Various coupling structures between the other one of the display board 210 and the jog board 310, and the first connector 220 will be described below.

Hereinafter, one or more examples will be described in which the first connector 220 is provided in the display board 210, and the first connector 220 is mechanically coupled and electrically connected to the jog board 310. A first direction D1 may be the thickness direction of the display board 210. A second direction D2 and a third direction D3, which are orthogonal to the first direction D1, correspond to lateral directions. The second direction D2 may be a left-right direction, and the third direction D3 may be a vertical direction.

In various embodiments, the manipulation panel 100 may include a reflector panel 100B. The reflector panel 100B may include a front portion 111 and side portions 112 extending from the front portion 111. In the reflector panel 100B, an opposite side to the front portion 111, that is, a rear portion, may be open at least in part. For example, the entire rear portion of the reflector panel 100B may be open. The front portion 111 and the side portions 112 form an accommodation space in which the display board 210 and the jog board 310 are accommodated. For example, the side portions 112 may extend rearward in the first direction D1 from an edge of the front portion 111. The front portion 111 may have a flat shape, or may have a partially or entirely curved shape.

At least one opening may be provided in the front portion 111. The at least one opening may include manipulation input openings for receiving a manipulation input from a user. The at least one opening may include indication openings for indicating an operation state of the electrical appliance. The manipulation input openings may include, for example, a jog manipulation opening 121 through which an operating shaft 331 of the jog switch 330, which will be described below, passes. The manipulation input openings may include switch openings 122 for switch elements. Buttons 123 for operating the switch elements may be provided in the switch openings 122. The indication openings may include first openings 124 for light-emitting elements, for example, light-emitting diodes (LEDs), a second opening 125 for a display element, and a third opening 126 for a sound generating element. The second opening 125 may be, for example, an opening for a seven-segment display element. The indication openings may include jog indication openings 127 for jog indication elements 241 to be described below.

The manipulation panel 100 may further include an exterior panel 100A positioned in front of the reflector panel 100B. The reflector panel 100B may be positioned at the rear of the exterior panel 100A in the first direction D1, and may be coupled to the exterior panel 100A. The front portion 111 of the reflector panel 100B faces the exterior panel 100A in the first direction D1. The exterior panel 100A may include a frame 501 and an indication manipulation panel 502. For example, the indication manipulation panel 502 may be implemented by a film attached to the outer surface of the frame 501. An opening 521, manipulation units 523, indication units 524, an indication unit 525, an opening 526, and jog indication units 527 may be provided in the indication manipulation panel 502. For example, the manipulation units 523 may be formed by indicating manipulable areas by printing on a surface of a film forming the indication manipulation panel 502. For example, the manipulation units 523 may each have a convexly protruding shape. For example, the indication units 524, the indication unit 525, and the jog indication units 527 may be formed such that light may be transmitted through the film forming the indication manipulation panel 502. For example, the indication units 524, the indication unit 525, and the jog indication units 527 may be subjected to dimming to scatter light.

The reflector panel 100B is coupled to the exterior panel 100A. The reflector panel 100B may be coupled to the inside of the frame 501 from the rear by a screw fastening method or the like. The opening 521 is aligned with the jog manipulation opening 121. A jog dial 410 is coupled to the operating shaft 331 that protrudes through the opening 521. The manipulation units 523 are aligned with the buttons 123. When the manipulation units 523 are pressed, the buttons 123 are pressed, and accordingly, switch elements, for example, tact switches 242 on the display board 210 to be described below, may be operated. The indication units 524 are aligned with the first openings 124. Through the indication units 524, lighting of indication elements, for example, light-emitting elements 243 on the display board 210 to be described below, may be confirmed. The indication unit 525 is aligned with the second opening 125. Through the indication unit 525, information indicated by a display element, for example, a display element 244 on the display board 210 to be described below, may be confirmed. The opening 526 is aligned with the third opening 126. A sound generated by a sound generating element 245 on the display board 210 to be described below is emitted through the opening 526. The jog indication units 527 are aligned with the jog indication openings 127. Through the jog indication units 527, lighting of the jog indication elements 241 on the display board 210 or the jog board 310 to be described below may be confirmed.

The display board 210 may be a printed circuit board. The display board 210 may be a single-sided printed circuit board or a double-sided printed circuit board. At least one electronic component is mounted on the display board 210. The electronic component may include at least one of an indication element and a manipulation element. A display module 200 is formed by mounting electronic components on the display board 210. The indication element may include a light-emitting element such as an LED, a display element that displays various pieces of information, and the like. The indication element may include a sound generating element that outputs an audible indication, such as a beeper. The manipulation element is, for example, an element used for input manipulation by the user, and may include, for example, a toggle switch, a tact switch, a touch panel, or the like. The touch panel may be integrated into the display element. A plurality of fastening holes 213, to be described below, for assembly with the manipulation panel 100, for example, the reflector panel 100B, may be provided in the display board 210.

The display board 210 according to various embodiments of the present disclosure may include a first surface (front surface) 211 on which at least one electronic component is mounted, and a second surface (rear surface) 212 that is opposite to the first surface 211. The first surface 211 faces the reflector panel 100B in the first direction D1. The display board 210 is accommodated in the accommodation space formed by the front portion 111 and the side portions 112 of the reflector panel 100B. The display board 210 is arranged on the inner side of the reflector panel 100B, i.e., in the accommodation space, such that the first surface 211 faces the front portion 111. The display board 210 may be coupled to the reflector panel 100B, for example, by a screw fastening method.

An electronic component including at least one of a manipulation element and an indication element is mounted on the first surface 211 of the display board 210. In the present embodiment, the manipulation element include, for example, the tact switches 242 that operate when pressed. When the display board 210 is coupled to the reflector panel 100B, the tact switches 242 are aligned with the switch openings 122. The buttons 123 correspond to the tact switches 242, respectively. The user may operate the tact switches 242 by directly pressing the buttons 123 to be described below, or by pressing the manipulation units 523 of the exterior panel 100A. Accordingly, a manipulation by the user may be input to the electrical appliance. The indication element may include the light-emitting elements 243. The light-emitting elements 243 may be, for example, LEDs. The indication element may include the display element 244, for example, a seven-segment display element. The indication element may include the sound generating element 245, for example, a beeper. When the display board 210 is coupled to the reflector panel 100B, the light-emitting elements 243 may be aligned with the first openings 124 of the reflector panel 100B, the display element 244 may be aligned with the second opening 125, and the sound generating element 245 may be aligned with the third opening 126.

The jog board 310 may be a printed circuit board. The jog board 310 may be a single-sided printed circuit board or a double-sided printed circuit board. The jog board 310 according to various embodiments of the present disclosure may include a first surface (front surface) 311 on which the jog switch 330 is mounted, and a second surface (rear surface) 312 that is opposite to the first surface 311. The first surface 311 of the jog board 310 faces the front portion 111 of the reflector panel 100B. The jog board 310 is accommodated in the accommodation space of the reflector panel 100B. The jog board 310 is arranged on the inner side of the reflector panel 100B, that is, in the accommodation space, such that the first surface 311 faces the front portion 111 of the reflector panel 100B. The jog board 310 may be coupled to the reflector panel 100B, for example, by a screw fastening method. A coupling structure between the jog board 310 and the reflector panel 100B will be described below.

The jog switch 330 may be, for example, a rotary switch, a tilting switch that may be manipulated in the left-right direction and/or the vertical direction, or the like. The jog switch 330 may be used to select a function of an electrical appliance to which the manipulation panel assembly 1 is applied, such as a washing machine or a dryer. For example, the jog switch 330 is a rotary switch. The jog switch 330 includes the operating shaft 331 to which the jog dial 410 is coupled. The operating shaft 331 may be, for example, in the form of a rotating shaft. The jog board 310 and the jog switch 330 constitute a jog module 300. When the jog board 310 is coupled to the reflector panel 100B, the operating shaft 331 protrudes from the front portion 111 of the reflector panel 100B through the jog manipulation opening 121. In addition, the operating shaft 331 protrudes from the exterior panel 100A through the opening 521 of the exterior panel 100A. The jog dial 410 is coupled to the protruding portion of the operating shaft 331. By turning the jog dial 410, a manipulation by the user may be input to the electrical appliance.

In various embodiments, the jog board 310 may be positioned to be spaced apart from the display board 210 rearward in the first direction D1. A jog through hole 231 is provided in the display board 210. The jog board 310 faces the manipulation panel 100, for example, the reflector panel 100B, through the jog through hole 231. The jog through hole 231 may have a size and shape that allow at least the operating shaft 331 of the jog switch 330 to pass through the jog through hole 231. The jog through hole 231 may have a size and shape that allow the jog board 310 to pass through the jog through hole 231. For example, the jog through hole 231 may have a circular shape, an elliptical shape, a polygonal shape, or a combination of two or more thereof. In addition, the jog through hole 231 may have a partially circular shape, a partially elliptical shape, a partially polygonal shape, or a combination of two or more thereof, with an open side in the second direction D2 or the third direction D3. The jog board 310 may have a circular shape, an elliptical shape, a polygonal shape, or a combination of two or more thereof. In the present embodiment, for example, the jog board 310 has an elliptical shape extending in the second direction D2.

The manipulation panel assembly 1 may include one or more jog indication elements 241 that emit light according to a manipulation of the jog switch 330. The jog indication elements 241 blink according to a manipulation of the jog switch 330 to indicate a function selected by the jog switch 330 or an operating state of the electrical appliance. For example, a plurality of jog indication elements 241 may be provided in the display board 210. The plurality of jog indication elements 241 may be provided around the jog through hole 231. A plurality of jog indication units 527 aligned with the plurality of jog indication elements 241 are provided in the exterior panel 100A, and a plurality of jog indication openings 127 aligned with the plurality of jog indication elements 241 are provided in the reflector panel 100B.

In a case in which the jog board 310 is positioned at the rear of the display board 210 in the first direction D1, when the jog indication elements 241 are provided in the jog board 310, the manipulation panel 100 is far from the jog indication elements 241, and thus, the brightness of the jog indication elements 241 viewed from the front of the manipulation panel 100 may be reduced. According to various embodiments of the present disclosure, because the jog indication elements 241 are provided in the display board 210, the jog indication elements 241 may be positioned close to the manipulation panel 100 even in a structure in which the jog board 310 is positioned at the rear of the display board 210. Accordingly, the decrease in the brightness of the jog indication elements 241 viewed from the front of the manipulation panel 100 may be reduced.

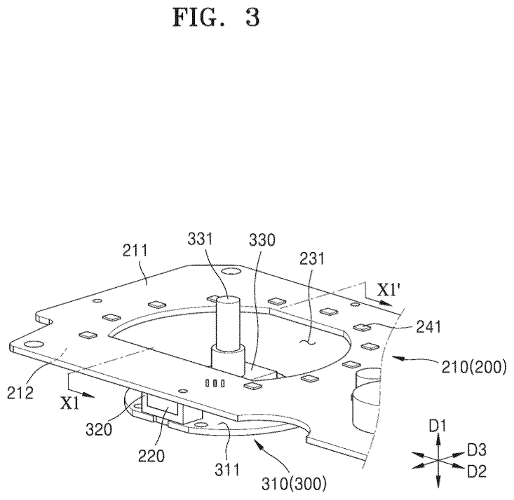

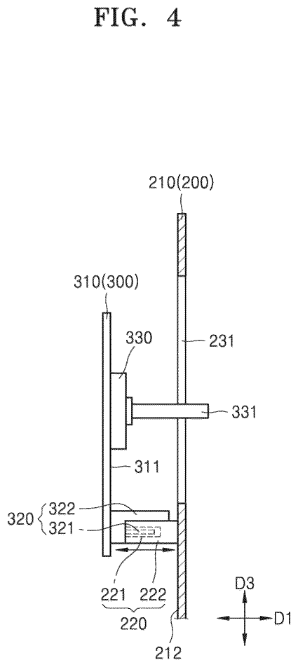

FIG. 3 is a partial perspective view illustrating an example of a coupling structure between the display board 210 and the jog board 310 using the first connector 220 in the manipulation panel assembly 1 for an electrical appliance illustrated in FIG. 1, according to various embodiments of the present disclosure. FIG. 4 is a cross-sectional view taken along line X1-X1′ of FIG. 3. Referring to FIGS. 1 to 4, the first connector 220 is provided in the display board 210. The first connector 220 is coupled to the jog board 310 by a connector connection method. The jog board 310 is positioned to be spaced apart from the display board 210 rearward in the first direction D1. The first connector 220 and a second connector 320 are coupled to each other in the first direction D1. To this end, the first connector 220 and the second connector 320 are provided on two surfaces of the display board 210 and the jog board 310 that face each other in the first direction D1, respectively. For example, the first connector 220 is provided on the rear surface of the display board 210, that is, the second surface 212, and the second connector 320 is provided on the front surface of the jog board 310, that is, the first surface 311. The first connector 220 may be provided around the jog through hole 231. The first connector 220 may be positioned adjacent to an edge of the jog through hole 231. In the present embodiment, the first connector 220 is positioned adjacent to a lower edge of the jog through hole 231 in the third direction D3.

The first connector 220 and the second connector 320 may have complementary shapes that may be coupled to each other in the first direction D1. Various commercially available connectors that may be coupled to each other in a male-female manner may be used as the first connector 220 and the second connector 320. For example, a first electrical contact 221 and a second electrical contact 321 that may be coupled to each other in a male-female manner may be provided in the first connector 220 and the second connector 320, respectively. For example, the second electrical contact 321 may have a pin shape, and the first electrical contact 221 may have a concave shape into which the second electrical contact 321 is inserted. Although not illustrated in the drawings, the first electrical contact 221 may have a pin shape, and the second electrical contact 321 may have a concave shape into which the first electrical contact 221 is inserted. Although not illustrated in detail in the drawings, a housing 222 of the first connector 220 and a housing 322 of the second connector 320 may also have complementary shapes that may be coupled to each other in the first direction D1. By coupling the first connector 220 and the second connector 320 to each other in the first direction D1, the display board 210 and the jog board 310 may be mechanically coupled and electrically connected to each other. Accordingly, the board module 400 may be formed, in which the display board 210 and the jog board 310 are coupled to each other.

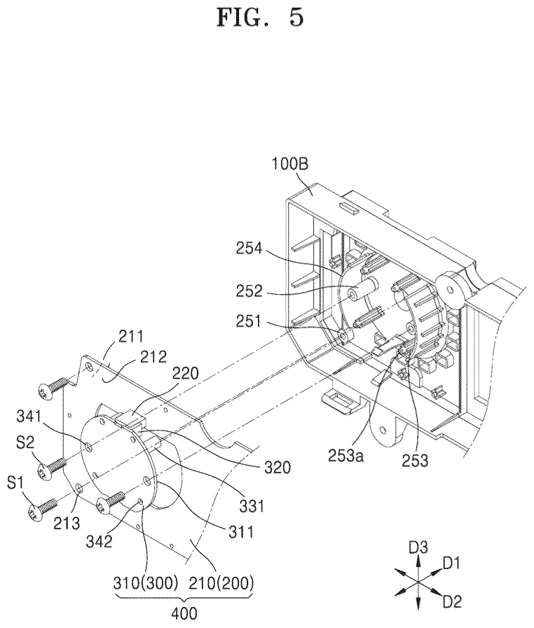

The board module 400 is coupled to the manipulation panel 100, for example, the reflector panel 100B. The manipulation panel 100 may include support ribs that support the jog board 310. The manipulation panel 100 include fastening bosses to which the jog board 310 is fastened. FIG. 5 is a partially exploded perspective view schematically illustrating an example of a structure in which the board module 400 is coupled to the reflector panel 100B. Referring to FIG. 5, fastening bosses 251 are provided in the reflector panel 100B. The fastening bosses 251 protrude rearward from the rear surface of the front portion 111 of the reflector panel 100B. The display board 210 is positioned such that the first surface 211 is supported by the fastening bosses 251. The fastening bosses 251 are aligned with the fastening holes 213. Screws S1 are inserted into the fastening holes 213 from the second surface 212 of the display board 210, and the screws S1 are fastened to the fastening bosses 251. Accordingly, the display board 210 may be coupled to the reflector panel 100B. Because the jog board 310 has been mechanically coupled to the display board 210 by the coupling between the first connector 220 and the second connector 320, the jog board 310 may also be coupled to the reflector panel 100B.

In various embodiments, the display board 210 may be first coupled to the reflector panel 100B. Thereafter, the second connector 320 may be coupled to the first connector 220 in the first direction D1 from the rear of the display board 210. Accordingly, the jog board 310 may be mechanically coupled and electrically connected to the display board 210.

For stable manipulation of the jog switch 330 via the jog dial 410, the jog board 310 may be firmly supported on the reflector panel 100B. To this end, the jog board 310 may be fastened to the reflector panel 100B by screws S2. Fastening bosses 252 are provided in the reflector panel 100B. The fastening bosses 252 protrude rearward from the rear surface of the front portion 111 of the reflector panel 100B. Fastening holes 341 are provided in the jog board 310. The jog board 310 is positioned such that the first surface 311 is supported by the fastening bosses 252. The fastening bosses 252 are aligned with the fastening holes 213. The screws S2 are inserted into the fastening holes 341 from the second surface 312 of the jog board 310, and the screws S2 are fastened to the fastening bosses 252. Accordingly, the jog board 310 may be firmly coupled to the reflector panel 100B. Although FIG. 5 illustrates two fastening bosses 252 and two fastening holes 341, three or more fastening bosses 252 and three or more fastening holes 341 may be provided.

Support ribs 253 that support the jog board 310 may be provided in the reflector panel 100B. The support ribs 253 protrude rearward from the rear surface of the front portion 111 of the reflector panel 110B. The first surface 311 of the jog board 310 is supported by the support ribs 253. Accordingly, the jog board 310 may be stably supported by the fastening bosses 252 and the support ribs 253. Although FIG. 5 illustrates four support ribs 253, the number of support ribs 253 is not limited thereto, and an appropriate number of support ribs 253 for stably supporting the jog board 310 may be provided in the reflector panel 100B.

Alignment units may be provided for alignment between the jog manipulation opening 121 and the operating shaft 331 of the jog switch 330. For example, the alignment units may include positioning holes 342 provided in the jog board 310, and positioning bosses 253a provided in the reflector panel 100B. The jog board 310 is positioned such that the positioning bosses 253a are inserted into the positioning holes 342. This enables stable alignment between the jog manipulation opening 121 and the operating shaft 331 of the jog switch 330. In addition, this enables stable alignment between the fastening bosses 252 and the fastening holes 341. Guide ribs 254 may be provided in the reflector panel 100B. The guide ribs 254 partially surround an edge of the jog board 310. When coupling the jog board 310 to the reflector panel 100B, the guide ribs 254 may facilitate alignment between the positioning holes 342 and the positioning bosses 253a, and alignment between the fastening holes 341 and the fastening bosses 252. In addition, the guide ribs 254 may serve to limit lateral movement of the jog board 310, that is, movement in the second direction D2 and the third direction D3.

In related-art washing machines and dryers, a display board and a jog board are manufactured in separate processes. A display module is manufactured by mounting electronic components on a display board. A jog module is manufactured by mounting a jog switch on a jog board. The display module and the jog module are individually coupled to a reflector panel, and the display board and the jog board are electrically connected to each other by a wire harness. Because the display module and the jog module are subjected to individual manufacturing and inspection processes, a manufacturing facility and an inspection facility are required for each of the display module and the jog module. In addition, an assembly process for assembling the display module to the reflector panel, an assembly process for assembling the jog module to the reflector panel, and a wire harness connection process are required.

According to the manipulation panel assembly 1 of the present disclosure, the display board 210 and the jog board 310 are mechanically coupled and electrically connected to each other by the first connector 220 and the second connector 320. Thus, the process of connecting the display board 210 to the jog board 310 by using a wire harness may be omitted, and thus, the process cost may be reduced. Because the board module 400 in which the display board 210 and the jog board 310 are mechanically coupled to each other by the first connector 220 and the second connector 320 may be assembled to the reflector panel 100B, the assembly process of the display board 210 and the jog board 310 may be simplified.

In addition, in related-art manipulation panel assembly, a jog board is supported by a separate support, and the support is coupled to a manipulation panel, for example, a reflector panel. That is, the support having a thickness is arranged between the jog board and the reflector panel. This structure may increase the manufacturing cost due to the support. According to the manipulation panel assembly 1 of the present disclosure, the jog board 310 is directly coupled to the reflector panel 100B, and thus, the manufacturing cost may be reduced.

In the above-described embodiment, the display board 210 and the jog board 310 are coupled to the reflector panel 100B, but this is only an example. Although not illustrated in the drawings, the reflector panel 100B may be omitted and the display board 210 and the jog board 310 may be directly coupled to the exterior panel 100A. In this case, structures that are described above as being provided in the front portion 111 of the reflector panel 100B may be provided in the exterior panel 100A, for example, the frame 501.

According to the manipulation panel assembly 1 of the present disclosure, the display module 200 including the display board 210, and the jog module 300 including the jog board 310 may be manufactured through a common process. In other words, the display board 210 and the jog board 310 may be formed by using a single integrated board. In various embodiments, the jog through hole 231 of the display board 210 has a size and shape that allow the jog board 310 to pass through the jog through hole 231. The jog through hole 231 is larger than the jog board 310. Thus, the jog board 310 may be arranged inside the jog through hole 231.

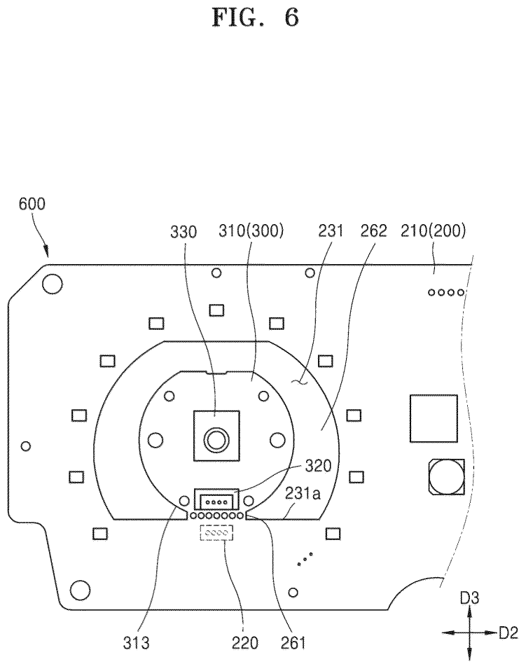

FIG. 6 illustrates an example of a structure in which the display module 200 and the jog module 300 are manufactured in an integrated manner. Referring to FIG. 6, the display board 210 and the jog board 310 are arranged in one integrated board 600. The display board 210 and the jog board 310 are separated from each other by a slit 262, and connected to each other by a perforated portion 261 crossing the slit 262. The perforated portion 261 includes, for example, a plurality of perforations spaced apart from each other. The perforated portion 261 may connect a portion of an edge of the jog board 310, to the display board 210. FIG. 6 illustrates an example in which the perforated portion 261 is provided at a lower edge of the jog board 310 in the third direction D3, but the perforated portion 261 may be provided at an upper edge of the jog board 310 in the third direction D3, or at two edges of the jog board 310 in the second direction D2. In addition, the jog board 310 may be connected to the display board 210 by two or more perforated portions 261. In a state in which the display board 210 and the jog board 310 are connected to each other by the perforated portion 261, processes such as printed circuit patterning on the display board 210 and the jog board 310, mounting of electronic components and the first connector 220 on the display board 210, or mounting of the jog switch 330 and the second connector 320 on the jog board 310 may be performed. Accordingly, the display module 200 and the jog module 300 may be manufactured through a common manufacturing process. Thereafter, the jog board 310 is separated from the integrated board 600 along the perforated portion 261. The remaining portion after the jog board 310 is separated from the integrated board 600 is the display board 210. The area occupied by the jog board 310 in the integrated board 600 is the jog through hole 231. Then, the board module 400 may be formed by coupling the first connector 220 to the second connector 320 as illustrated in FIGS. 3 and 4.

According to the above configuration, because the jog module 300 and the display module 200 may be manufactured through an integrated process, the manufacturing cost of the jog module 300 and the display module 200 may be reduced. In addition, because the processes of inspecting the jog module 300 and the display module 200 may be performed in an integrated manner, the process cost may be reduced.

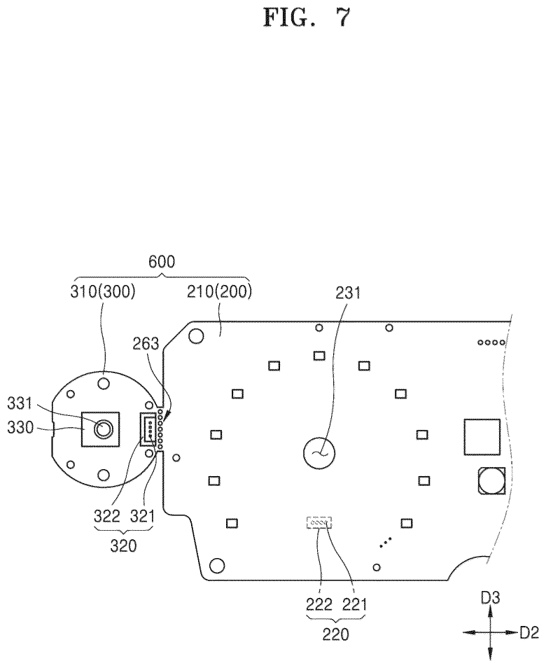

The structure in which the display module 200 and the jog module 300 are manufactured in an integrated manner is not limited to the example illustrated in FIG. 6. FIG. 7 illustrates an example of a structure in which the display module 200 and the jog module 300 are manufactured in an integrated manner. Referring to FIG. 7, the display board 210 and the jog board 310 are arranged in one integrated board 600. The jog board 310 may be arranged in one side portion of the display board 210 in a lateral direction, for example, in the second direction D2. FIG. 7 illustrates that the jog board 310 is arranged in a left side portion of the display board 210, but the jog board 310 may be arranged in a right side portion of the display board 210 or in two side portions in the third direction D3. The display board 210 and the jog board 310 are connected to each other by a perforated portion 263. The perforated portion 263 includes, for example, a plurality of perforations spaced apart from each other. In a state in which the display board 210 and the jog board 310 are connected to each other by the perforated portion 263, processes such as printed circuit patterning on the display board 210 and the jog board 310, mounting of electronic components and the first connector 220 on the display board 210, or mounting of the jog switch 330 and the second connector 320 on the jog board 310 may be performed. Accordingly, the display module 200 and the jog module 300 may be manufactured through a common process. Thereafter, the jog board 310 is separated from the integrated board 600 along the perforated portion 263. The remaining portion after the jog board 310 is separated from the integrated board 600 is the display board 210. In this case, the jog through hole 231 may have a size and shape that allow at least the operating shaft 331 of the jog switch 330 to pass through the jog through hole 231. Then, the board module 400 may be formed by coupling the first connector 220 to the second connector 320 as illustrated in FIGS. 3 and 4.

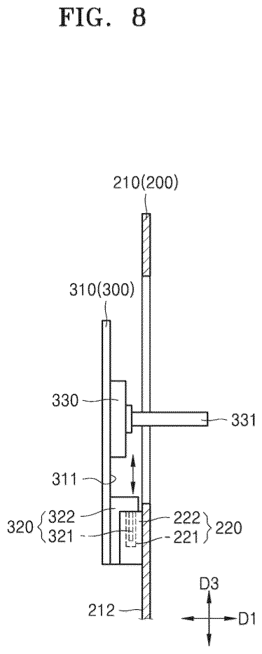

The first connector 220 and the second connector 320 may be coupled to each other in a lateral direction of the display board 210 that is orthogonal to the first direction D1, that is, in the second direction D2 or the third direction D3. The lateral direction may be, for example, a direction parallel to a surface of the display board 210, for example, the first surface 211. FIG. 8 is a cross-sectional view illustrating an example of a coupling structure between the first connector 220 and the second connector 320, and corresponding to FIG. 4. Referring to FIG. 8, the first connector 220 is provided on the second surface 212 of the display board 210. The first connector 220 has the first electrical contact 221 extending in a lateral direction, for example, in the third direction D3. The second connector 320 is provided on the first surface 311 of the jog board 310. The second connector 320 has the second electrical contact 321 extending in a lateral direction, for example, in the third direction D3. The second connector 320 may be coupled to the first connector 220 by aligning the jog board 310 with the display board 210 such that the first connector 220 and the second connector 320 face each other in the third direction D3, and then pushing the jog board 310 in a lateral direction, for example, in the third direction D3. Although not illustrated in the drawings, the first connector 220 and the second connector 320 may be coupled to each other in the second direction D2. In this case, the first connector 220 and the second connector 320 may be provided in the display board 210 and the jog board 310, respectively, to face each other in the second direction D2. The first electrical contact 221 and the second electrical contact 321 may each extend in the second direction D2.

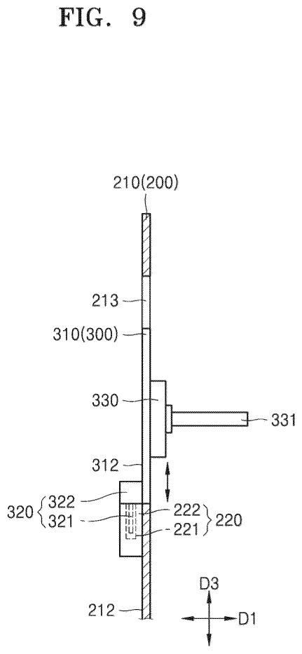

In the above-described embodiments, the jog board 310 is positioned to be spaced apart from the display board 210 rearward in the first direction D1, but the jog board 310 may be positioned parallel to the display board 210. FIG. 9 is a cross-sectional view illustrating an example of a coupling structure between the first connector 220 and the second connector 320, and corresponding to FIG. 4. Referring to FIG. 9, the jog board 310 is positioned parallel to the display board 210 in a lateral direction. For example, the jog board 310 may be arranged parallel to the display board 210 in a lateral direction inside the jog through hole 231 provided in the display board 210. The first connector 220 may be provided on the first surface 211 or the second surface 212 of the display board 210. The second connector 320 may be provided parallel to the first connector 220 in a lateral direction in the jog board 310. In the present embodiment, the first connector 220 is provided on the second surface 212 of the display board 210. The first connector 220 has the first electrical contact 221 extending in a lateral direction, for example, in the third direction D3. The second connector 320 is provided on the second surface 312 of the jog board 310. The second connector 320 has the second electrical contact 321 extending in a lateral direction, for example, in the third direction D3. The second connector 320 may be coupled to the first connector 220 by aligning the jog board 310 inside the jog through hole 231 of the display board 210 such that the first connector 220 and the second connector 320 face each other in the third direction D3, and then pushing the jog board 310 in a lateral direction, for example, in the third direction D3. Although not illustrated in the drawings, the first connector 220 and the second connector 320 may be coupled to each other in the second direction D2. In this case, the first connector 220 and the second connector 320 may be provided in the display board 210 and the jog board 310, respectively, to face each other in the second direction D2. The first electrical contact 221 and the second electrical contact 321 may each extend in the second direction D2.

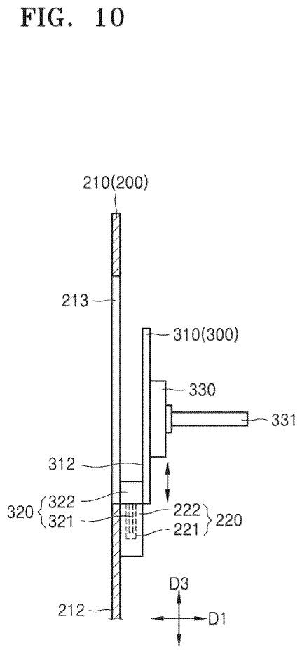

The jog board 310 may be positioned to be spaced from the display board 210 forward in the first direction D1, that is, toward the reflector panel 100B. FIG. 10 is a cross-sectional view illustrating an example of a coupling structure between the first connector 220 and the second connector 320, and corresponding to FIG. 4. Referring to FIG. 10, the jog board 310 is positioned to be spaced apart from the display board 210 forward in the first direction D1. In the present embodiment, the first connector 220 and the second connector 320 are coupled to each other in a lateral direction, for example, in the third direction D3. The first connector 220 may be provided on the first surface 211 of the display board 210. The first connector 220 has the first electrical contact 221 extending in a lateral direction, for example, in the third direction D3. The second connector 320 may be provided on the second surface 312 of the jog board 310 to be parallel to the first connector 220 in a lateral direction, for example, in the third direction D3. The second connector 320 has the second electrical contact 321 extending in a lateral direction, for example, in the third direction D3. The second connector 320 may be coupled to the first connector 220 by aligning the jog board 310 in front of the display board 210 such that the first connector 220 and the second connector 320 face each other in the third direction D3, and then pushing the jog board 310 in a lateral direction, for example, in the third direction D3. Although not illustrated in the drawings, the first connector 220 and the second connector 320 may be coupled to each other in the second direction D2. In this case, the first connector 220 and the second connector 320 may be provided in the display board 210 and the jog board 310, respectively, to face each other in the second direction D2. The first electrical contact 221 and the second electrical contact 321 may each extend in the second direction D2. Although not illustrated in the drawings, the first connector 220 and the second connector 320 may be coupled to each other in the first direction D1. In this case, the first connector 220 may be provided on the first surface 211 of the display board 210, and the second connector 320 may be provided on the second surface 312 of the jog board 310.

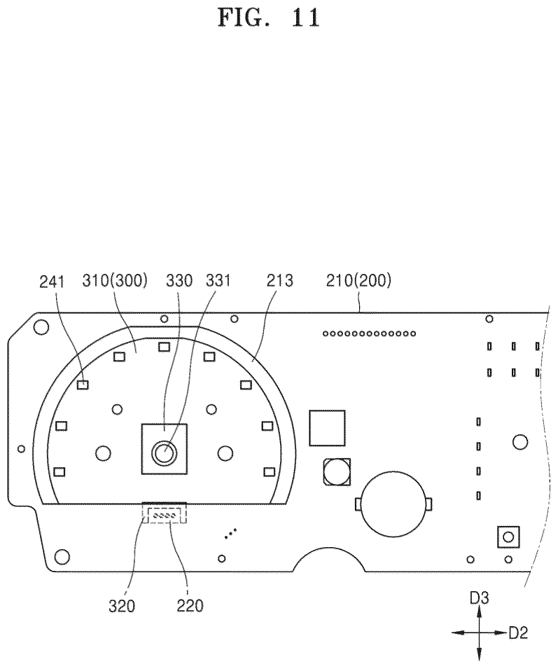

In the above-described embodiments, the jog indication elements 241 are provided in the display board 210, but this is only an example. FIG. 11 is a schematic plan view of the manipulation panel assembly 1 according to various embodiments of the present disclosure. In FIG. 11, the manipulation panel 100 is omitted. Referring to FIG. 11, the jog indication elements 241 are provided in the jog board 310.

In related-art manipulation panel assembly, a jog board is supported by a separate support, and the support is coupled to a manipulation panel, for example, a reflector panel. That is, the support having a thickness is arranged between the jog board and the reflector panel. This structure may increase the manufacturing cost due to the support. In a case in which jog indication elements are provided in the jog board, the manipulation panel is far from the jog indication elements, and thus, the brightness of the jog indication elements viewed from the front of the manipulation panel may be reduced.

According to the present disclosure, because the jog board 310 is coupled to the display board 210 and the jog board 310 is directly coupled to the reflector panel 100B, the jog board 310 may be positioned close to the reflector panel 100B. Thus, even when the jog indication elements 241 are positioned in the jog board 310, the decrease in the brightness of the jog indication elements 241 viewed from the front of the manipulation panel 100 may be reduced. In addition, according to the structure illustrated in FIGS. 9 and 10, in which the jog board 310 is positioned parallel to the display board 210 or positioned in front of the display board 210, when the jog indication elements 241 are positioned in the jog board 310, the decrease in the brightness of the jog indication elements 241 viewed from the front of the manipulation panel 100 may be further reduced.

The jog indication elements 241 may be provided in at least one of the display board 210 and the jog board 310. For example, although not illustrated in the drawings, some of the jog indication elements 241 may be provided in the display board 210 and the other may be provided in the jog board 310.

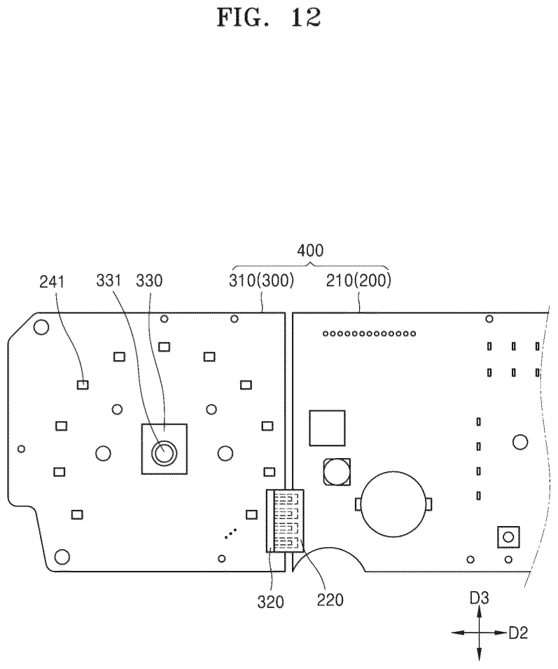

FIG. 12 is a schematic plan view of the manipulation panel assembly 1 according to various embodiments of the present disclosure. In FIG. 12, the manipulation panel 100 is omitted. Referring to FIG. 12, the jog board 310 is positioned in one side portion of the display board 210 in a lateral direction, for example, in a left side portion of the display board 210 in the second direction D2. The jog indication elements 241 are provided in the jog board 310. The first connector 220 is provided near the left side portion of the display board 210. The second connector 320 is provided near a right side portion of the jog board 310 that faces the left side portion of the display board 210.

The jog board 310 may be positioned to be spaced apart from the display board 210 rearward or forward. In this case, as described above, the first connector 220 and the second connector 320 may be coupled to each other in the first direction D1 or the second direction D2. The jog board 310 may be positioned parallel to the display board 210. In this case, the first connector 220 and the second connector 320 may be provided on the first surface 211 or 311 or the second surface 212 or 312 of the display board 210 and the jog board 310, respectively, and may be coupled to each other in the second direction D2 as described above.

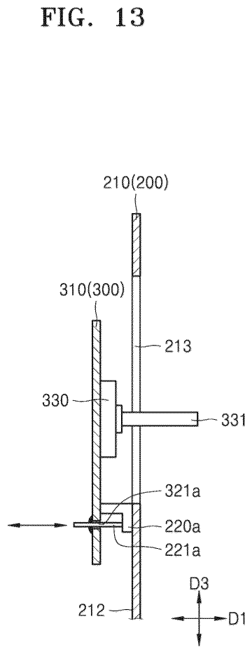

In the above-described embodiments, the display board 210 and the jog board 310 are mechanically coupled and electrically connected to each other by a connector-connector coupling structure. However, the mechanical/electrical coupling/connection structure between the display board 210 and the jog board 310 is not limited thereto. For example, the first connector may be provided in any one of the display board 210 and the jog board 310, and the first connector may be soldered to the other one of the display board 210 and the jog board 310. FIG. 13 is a schematic cross-sectional view of the manipulation panel assembly 1 according to various embodiments of the present disclosure, and corresponding to FIG. 4. Referring to FIG. 13, the jog board 310 is positioned to be spaced apart from the display board 210 rearward. A first connector 220a is provided in any one of the display board 210 and the jog board 310, for example, in the display board 210. The first connector 220a may include, for example, an electrical contact 221a. A through hole 321a is provided in the other one of the display board 210 and the jog board 310, for example, in the jog board 310. The through hole 321a is connected to an electrical circuit of the jog board 310. The electrical contact 221a is inserted into the through hole 321a by aligning the jog board 310 at the rear of the display board 210 such that the electrical contact 221a of the first connector 220a is aligned with the through hole 321a in the first direction D1, and then pushing the jog board 310 in the first direction D1, for example, forward. In this state, for example, the electrical contact 221a of the first connector 220a is coupled to the jog board 310 through soldering from the second surface 312 of the jog board 310. The first connector 220a is mechanically and electrically coupled to the jog board 310. Accordingly, the board module 400 may be formed, in which the display board 210 and the jog board 310 are mechanically coupled and electrically connected to each other.

Although not illustrated in the drawings, the first connector 220a may be provided in the jog board 310, and the through hole 321a may be provided in the display board 210. In addition, the jog board 310 may be positioned to be spaced apart from the display board 210 forward. In addition, the jog board 310 may be positioned parallel to the display board 210. In this case, the electrical contact 221a of the first connector 220a may have a shape that extends in a lateral direction and is bent in the first direction D1.

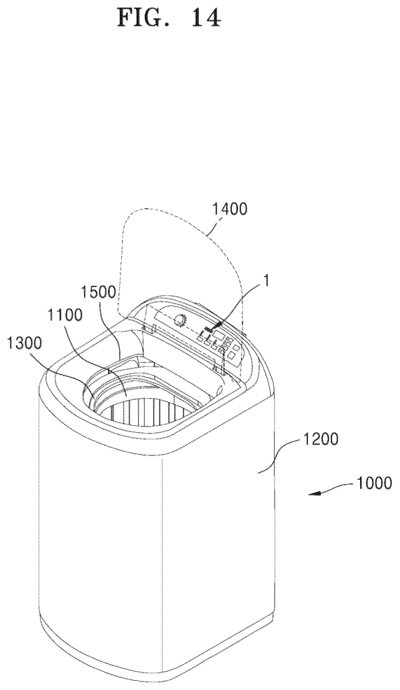

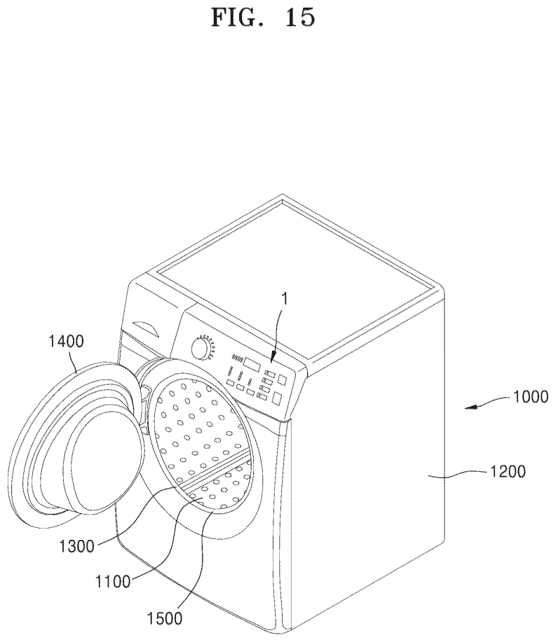

FIGS. 14 and 15 are schematic perspective views of electrical appliances according to various embodiments of the present disclosure. The electrical appliance illustrated in FIG. 14 is a top-loading washing machine. The electrical appliance illustrated in FIG. 15 is a front-loading washing machine, also known as a drum-type washing machine. Referring to FIGS. 14 and 15, the washing machine may include a main body 1000 and the manipulation panel assembly 1 for receiving a manipulation input for wash settings or spin-drying settings and indicating an operation state of the washing machine.

The main body 1000 may include components for performing functions of the washing machine. For example, the main body 1000 may include a tub 1300 (may be referred to as a “first tub”), a washing tub 1100 that rotates inside the tub 1300, a laundry inlet 1500 through which laundry is loaded into the washing tub 1100, and a door 1400 for opening and closing the laundry inlet 1500. For example, a housing 1200 forms an exterior of the main body 1000. The laundry inlet 1500 may be formed as an opening of the housing 1200. The door 1400 may be mounted on the housing 1200 to be rotatable by, for example, a hinge. The tub 1300 is provided inside the housing 1200 to store water. The tub 1300 may have a substantially cylindrical shape with a tub opening formed on one side thereof. The tub 1300 may be arranged inside the housing 1200 such that the tub opening corresponds to the laundry inlet 1500. A damper that reduces vibration caused by rotation of the washing tub 1100 may be arranged between the tub 1300 and the housing 1200. A washing tub opening is provided in the washing tub 1100. The washing tub 1100 may be arranged inside the tub 1300 such that the washing tub opening corresponds to the laundry inlet 1500 and the tub opening. Laundry may be accommodated in the washing tub 1100 sequentially through the laundry inlet 1500, the tub opening, and the washing tub opening, or may be unloaded from the washing tub 1100. In the front-loading washing machine illustrated in FIG. 15, the washing tub 1100 may be referred to as a drum. The washing tub 1100 may rotate inside the tub 1300 to perform each operation according to washing, rinse, and/or spin-drying cycles. A plurality of through hole are formed in a cylindrical wall of the washing tub 1100 to allow water stored in the tub 1300 to flow into or out of the washing tub 1100. Although not illustrated in the drawings, the main body 1000 may include a driving device for rotating the washing tub 1100, a water supply and drainage structure for supplying water to the washing tub 1100 and discharging water from the washing tub 1100, and the like.

The manipulation panel assembly 1 may have the structure as illustrated in FIGS. 1 to 13. The manipulation panel assembly 1 may be coupled to the main body 1000. The manipulation panel 1 may form an exterior of the washing machine together with the housing 1200. For example, as illustrated in FIGS. 14 and 15, the manipulation panel assembly 1 may be positioned adjacent to the door 1400. A manipulation input through the indication manipulation panel 502 and the jog dial 410 of the manipulation panel 100 may be delivered, as a manipulation signal, to a main board (not shown) via the display board 210. The main board may drive and control the main body 1000 according to the operation signal. A manipulation state of the main body 1000 may be indicated through the indication manipulation panel 502 of the manipulation panel 100.

The washing machine may also include a drying function. Although not illustrated in the drawings, the electrical appliance may be a dryer. The main body 1000 may include a drying container in which objects to be dried, for example, laundry, is accommodated, a heat supply structure for supplying hot air into the drying container, a driving structure for rotating the drying container as needed, and the like. The electrical appliance may be a spin-dryer. The main body 1000 may include a spin-drying tub, a drainage structure for discharging water from the spin-drying tub, a driving structure for rotating the spin-drying tub, and the like. The electrical appliance may be a dishwasher.

Although various effects of an electrical appliance including the manipulation panel assembly 1, for example, a washing machine, have been described in the present disclosure, the effects of the present disclosure are not limited to the foregoing. Other effects not mentioned herein would be clearly understood by those of skill in the art from the foregoing description.

A washing machine according to an aspect of the present disclosure includes a main body, and a manipulation panel assembly to receive a manipulation input for wash settings or spin-drying settings, and indicate an operation state of the washing machine. The main body may include a tub, a washing tub that rotates inside the tub, a laundry inlet through which laundry is loaded into the washing tub, and a door to open and close the laundry inlet. The manipulation panel assembly includes: a display board; a jog board on which a jog switch is mounted; a first connector arranged in any one of the display board and the jog board, and coupled to the other one of the display board and the jog board; and a manipulation panel in which the display board and the jog board are accommodated.

In various embodiments, a board module may be formed in which the display board and the jog board are coupled to each other by the first connector.

In various embodiments, the jog board may be positioned to be spaced apart from the display board rearward in a thickness direction of the display board.

In various embodiments, the jog board may be positioned parallel to the display board.

In various embodiments, the first connector may be soldered to the other one of the display board and the jog board.

In various embodiments, the manipulation panel assembly may include a second connector arranged in the other one of the display board and the jog board, and electrically and mechanically coupled to the first connector.

In various embodiments, the first connector and the second connector may be coupled to each other in the thickness direction of the display board.

In various embodiments, the first connector and the second connector may be coupled to each other in a lateral direction that is orthogonal to the thickness direction of the display board.

In various embodiments, a jog through hole may be arranged in the display board, and the jog board may face the manipulation panel through the jog through hole.

In various embodiments, the jog board may be positioned in one side portion of the display board in a lateral direction that is orthogonal to the thickness direction of the display board.

In various embodiments, the manipulation panel may include support ribs to support the jog board, and fastening bosses to which the jog board is fastened.

In various embodiments, the manipulation panel may include a reflector panel and an exterior panel that is positioned in front of the reflector panel, and the jog board and the display board may be coupled to the reflector panel.

In various embodiments, the support ribs to support the jog board, and the fastening bosses to which the jog board is fastened may be arranged in the reflector panel.

In various embodiments, the manipulation panel assembly may include jog indication elements to emit light according to a manipulation of the jog switch, and the jog indication elements may be provided in the display board.

In various embodiments, the manipulation panel assembly may include jog indication elements to emit light according to a manipulation of the jog switch, and the jog indication elements may be provided in the jog board.

An electrical appliance according to an aspect of the present disclosure includes: a main body; and the above-described manipulation panel assembly for at least one of manipulation input and display of an operation state of the main body. The manipulation panel assembly includes: a display board; a jog board on which a jog switch is mounted; a first connector arranged in any one of the display board and the jog board, and coupled to the other one of the display board and the jog board; and a manipulation panel in which the display board and the jog board are accommodated.

In various embodiments, the first connector may be soldered to the other one of the display board and the jog board.

In various embodiments, the manipulation panel assembly may include a second connector arranged in the other one of the display board and the jog board, and electrically and mechanically coupled to the first connector.

In various embodiments, the manipulation panel may include a reflector panel and an exterior panel that is positioned in front of the reflector panel, the jog board and the display board may be coupled to the reflector panel, and support ribs to support the jog board, and the fastening bosses to which the jog board is fastened may be arranged in the reflector panel.

In various embodiments, the electrical appliance may further include jog indication elements to emit light according to a manipulation of the jog switch, and the jog indication elements may be provided in any one of the display board and the jog board.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A washing machine comprising:
a main body comprising:
a first tub;
a washing tub rotatable inside the first tub;
a laundry inlet through which laundry is loaded into the washing tub; and
a door configured to open and close the laundry inlet; and
a manipulation panel assembly configured to:
receive a manipulation input for wash settings or spin-drying settings; and
display an operation state of the washing machine,
wherein the manipulation panel assembly comprises:
a display board;
a jog board on which a jog switch is mounted;
a first connector on any one of the display board and the jog board, and coupled to the other one of the display board and the jog board; and
a manipulation panel accommodating the display board and the jog board.

2. The washing machine of claim 1, wherein the display board and the jog board are coupled to each other by the first connector, and form a board module.

3. The washing machine of claim 1, wherein the jog board is spaced apart from the display board rearward in a thickness direction of the display board.

4. The washing machine of claim 1, wherein the jog board is parallel to the display board.

5. The washing machine of claim 1, wherein the first connector is soldered to the other one of the display board and the jog board.

6. The washing machine of claim 1, further comprising a second connector on the display board in a state in which the first connector is on the jog board, or on the jog board in a state in which the first connector is on the display board, and electrically and mechanically coupled to the first connector.

7. The washing machine of claim 6, wherein the first connector and the second connector are coupled to each other in a thickness direction of the display board.

8. The washing machine of claim 6, wherein the first connector and the second connector are coupled to each other in a lateral direction that is orthogonal to a thickness direction of the display board.

9. The washing machine of claim 1, further comprising a jog through hole in the display board,
wherein the jog board faces the manipulation panel through the jog through hole.

10. The washing machine of claim 1, wherein the jog board is in one side portion of the display board in a lateral direction that is orthogonal to a thickness direction of the display board.

11. The washing machine of claim 1, wherein the manipulation panel comprises:
one or more support ribs configured to support the jog board; and
one or more fastening bosses to which the jog board is fastened.

12. The washing machine of claim 11, wherein the manipulation panel comprises a reflector panel and an exterior panel in front of the reflector panel, and
wherein the jog board and the display board are coupled to the reflector panel.

13. The washing machine of claim 12, wherein the one or more support ribs are configured to support the jog board, and the one or more fastening bosses are in the reflector panel.

14. The washing machine of claim 1, further comprising jog indication elements configured to emit light based on a manipulation of the jog switch, and
wherein the jog indication elements are in the display board.

15. The washing machine of claim 1, further comprising jog indication elements configured to emit light based on a manipulation of the jog switch, and
wherein the jog indication elements are in the jog board.
